(19) United States
(12) Patent Application Publication
(10) Pub. No.: US 2023/0087741 A1
(43) Pub. Date: Mar. 23, 2023

(54) PROCESSING APPARATUS, ATTENDANCE CHECK SYSTEM, PROCESSING METHOD, AND NON-TRANSITORY STORAGE MEDIUM

(71) Applicant: NEC Corporation, Tokyo (JP)

(72) Inventor: Fumiyuki MIYAHARA, Tokyo (JP)

(73) Assignee: NEC Corporation, Tokyo (JP)

(21) Appl. No.: 17/903,651

(22) Filed: Sep. 6, 2022

(30) Foreign Application Priority Data
Sep. 21, 2021 (JP) 2021-153149

(51) Int. Cl. G07C 1/10; H04L 61/5007; G06Q 50/20

(52) U.S. Cl. CPC G07C 1/10; H04L 61/5007; G06Q 50/205

(57) ABSTRACT

To provide a new technique for checking attendance of a student, the present invention provides a processing apparatus 10 including: an acquisition unit 11 that acquires an internet protocol (IP) address of a student terminal; a decision unit 12 that decides whether a student is present in a first area, based on an IP address of the student terminal; and an attendance check unit 13 that performs an attendance check of a student, based on a result of a decision whether a student is present in the first area.

This application is based upon and claims the benefit of priority from Japanese patent application No. 2021-153149, filed on Sep. 21, 2021, the disclosure of which is incorporated herein in its entirety by reference.

### TECHNICAL FIELD

The present invention relates to a processing apparatus, an attendance check system, a processing method, and a program.

### BACKGROUND ART

A technique related to the present invention is disclosed in PTLs 1 and 2.

PTL 1 (Japanese Patent Application Publication No. 2003-141590) discloses an attendance check apparatus that performs an attendance check of a student. The attendance check apparatus performs an attendance check of a student by reading identification information about a student by a school attendee detection apparatus installed at a school gate of a school. Then, when the attendance check apparatus detects a student who is absent without an absence notification, based on attendance check data and absence notification data, the attendance check apparatus notifies a guardian of the detected student with a message such as “Your child is absent. Please notify school about reason for absence” by using a means such as telephone, FAX, and e-mail.

PTL 2 (Japanese Patent Application Publication No. 2018-32276) discloses an educational learning activity support system capable of collecting various pieces of data that may be acquired in relation to an educational activity of a teacher and a learning activity of a student, also easily generating data in a uniform format from the collected data, and displaying the various pieces of data in vertically and horizontally association with each other in an analyzable manner.

### DISCLOSURE OF THE INVENTION

A challenge is to provide a new technique for checking attendance of a student.

The present invention provides a processing apparatus including:

an acquisition unit that acquires an internet protocol (IP) address of a student terminal;

a decision unit that decides whether a student is present in a first area, based on an IP address of the student terminal; and

an attendance check unit that performs an attendance check of a student, based on a result of a decision whether a student is present in the first area.

Further, the present invention provides an attendance check system including:

the processing apparatus described above; and a student terminal.

Further, the present invention provides a processing method including,

executed by a computer;

an acquisition step of acquiring an IP address of a student terminal;

a decision step of deciding whether a student is present in a first area, based on an IP address of the student terminal; and

an attendance check step of performing an attendance check of a student, based on a result of a decision whether a student is present in the first area.

Further, the present invention provides a program causing a computer to function as:

an acquisition unit that acquires an IP address of a student terminal;

a decision unit that decides whether a student is present in a first area, based on an IP address of the student terminal; and

an attendance check unit that performs an attendance check of a student, based on a result of a decision whether a student is present in the first area.

The present invention achieves a new technique for checking attendance of a student.

### BRIEF DESCRIPTION OF THE DRAWINGS

FIG. 1 is a diagram illustrating one example of a functional block diagram of an attendance check system according to the present example embodiment.

FIG. 2 is a diagram illustrating one example of a hardware configuration of a processing apparatus according to the present example embodiment.

FIG. 3 is a diagram illustrating one example of a functional block diagram of the processing apparatus according to the present example embodiment.

FIG. 4 is a flowchart illustrating one example of a flow of processing of the processing apparatus according to the present example embodiment.

FIG. 5 is a diagram schematically illustrating one example of information processed by the processing apparatus according to the present example embodiment.

FIG. 6 is a diagram schematically illustrating one example of information processed by the processing apparatus according to the present example embodiment.

FIG. 7 is a diagram schematically illustrating one example of information processed by the processing apparatus according to the present example embodiment.

FIG. 8 is a diagram schematically illustrating one example of information processed by the processing apparatus according to the present example embodiment.

FIG. 9 is a diagram schematically illustrating one example of information processed by the processing apparatus according to the present example embodiment.

### DESCRIPTION OF EMBODIMENTS

Hereinafter, example embodiments of the present invention will be described with reference to the drawings. Note that, in all of the drawings, a similar component has a similar reference sign, and description thereof will be appropriately omitted.

### First Example Embodiment

### “Overall Perspective and Overview”

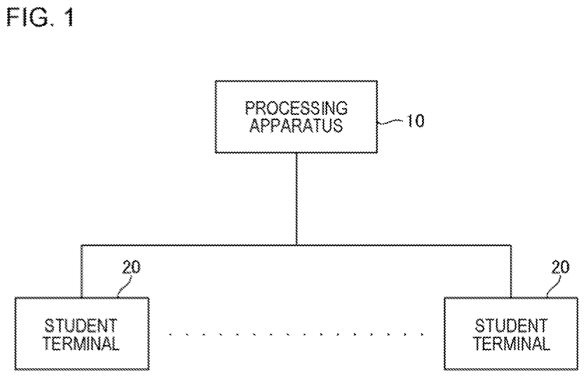

First, an overall perspective and an overview of an attendance check system according to the present example embodiment will be described. As illustrated in FIG. 1, the attendance check system according to the present example embodiment includes a processing apparatus 10 and a plurality of student terminals 20.

The student terminal 20 is a terminal used by a student. The student terminal 20 is used in an activity at school such as, for example, a class. Examples of a usage scene include viewing of a digital textbook and a digital teaching material, learning using a digital collection of questions and the like, management of attendance and grades, communication using a chat function and the like, information collection using a web browser, usage of various applications, and the like, which are not limited thereto. It is assumed that one student uses one student terminal 20. A personal computer (PC), a tablet terminal, a smartphone, and the like are exemplified as the student terminal 20, which are not limited thereto.

When the processing apparatus 10 acquires an IP address of each of the plurality of student terminals 20, the processing apparatus 10 decides whether a student is present in a predetermined area, based on the IP address. Then, the processing apparatus 10 performs an attendance check of the student, based on the decision result.

The attendance check system according to the present example embodiment achieves an attendance check technique that can be used at school being prepared for one student to use one student terminal 20. Then, an attendance check is performed by using the student terminal 20, and thus labor and time of a teacher can be further reduced as compared to a conventional means such as a roll call. Further, a position of a student is checked by using an IP address of the student terminal 20, and an attendance check is performed based on the result, and thus a highly reliable attendance check is achieved with a relatively simple configuration.

### “Configuration of Student Terminal 20”

A configuration of the student terminal 20 is not particularly limited. A configuration of various terminals for global and innovation gateway for all (GIGA) schools can be adopted. Note that, a special characteristic provided in the student terminal 20 for achieving an effect (of an attendance check of a student) according to the present example embodiment will be appropriately described in description of a configuration of the processing apparatus 10 below.

### “Configuration of Processing Apparatus 10”

Next, the configuration of the processing apparatus 10 will be described in detail.

### -Hardware Configuration-

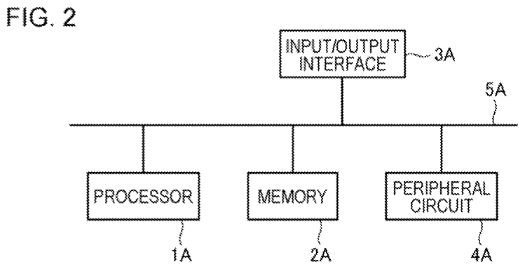

First, one example of a hardware configuration of the processing apparatus 10 will be described. FIG. 2 is a diagram illustrating a hardware configuration example of the processing apparatus 10. Each functional unit included in the processing apparatus 10 is achieved by any combination of hardware and software concentrating on as a central processing unit (CPU) of any computer, a memory, a program loaded into the memory, a storage unit such as a hard disc that stores the program (that can also store a program downloaded from a storage medium such as a compact disc (CD), a server on the Internet, and the like in addition to a program previously stored at a stage of shipping of an apparatus), and a network connection interface. Then, various modification examples of an achievement method and an apparatus thereof are understood by a person skilled in the art.

As illustrated in FIG. 2, the processing apparatus 10 includes a processor 1A, a memory 2A, an input/output interface 3A, a peripheral circuit 4A, and a bus 5A. Various modules are included in the peripheral circuit 4A. The processing apparatus 10 may not include the peripheral circuit 4A. Note that, the processing apparatus 10 may be formed of a plurality of apparatuses separated physically and/or logically, or may be formed of one apparatus integrated physically and logically. When each apparatus is formed of a plurality of apparatuses separated physically and/or logically, each of the plurality of apparatuses can include the hardware configuration described above.

The bus 5A is a data transmission path for the processor 1A, the memory 2A, the peripheral circuit 4A, and the input/output interface 3A to transmit and receive data to and from one another. The processor 1A is an arithmetic processing apparatus such as a CPU and a graphics processing unit (GPU), for example. The memory 2A is a memory such as a random access memory (RAM) and a read only memory (ROM), for example. The input/output interface 3A includes an interface for acquiring information from an input apparatus, an external apparatus, an external server, an external sensor, and the like, an interface for outputting information to an output apparatus, an external apparatus, an external server, and the like, and the like. The input apparatus is, for example, a keyboard, a mouse, a microphone, and the like. The output apparatus is, for example, a display, a speaker, a printer, a mailer, and the like. The processor 1A can output an instruction to each of modules, and perform an arithmetic operation, based on an arithmetic result of the modules.

### -Functional Configuration-

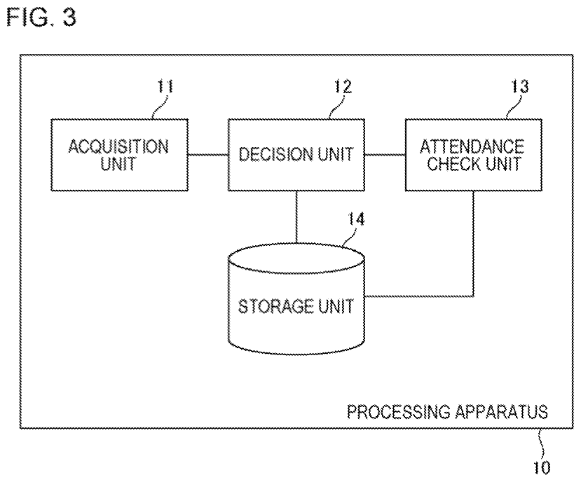

Next, one example of a functional configuration of the processing apparatus 10 will be described. FIG. 3 illustrates one example of a functional block diagram of a processing apparatus 10 according to the present example embodiment. As illustrated, the processing apparatus 10 includes an acquisition unit 11, a decision unit 12, an attendance check unit 13, and a storage unit 14.

The acquisition unit 11 acquires an IP address of each of the plurality of student terminals 20. The acquisition unit 11 receives each IP address from each of the plurality of student terminals 20.

A plurality of wireless local area network (LAN) access points are installed at school. Then, under a situation where the student terminal 20 is communicable with any of the wireless LAN access points, the student terminal 20 is set in such a way as to be connected to the Internet via the wireless LAN access point. On the other hand, under a situation where the student terminal 20 cannot communicate with any of the wireless LAN access points, the student terminal 20 can be connected to the Internet via a private wireless LAN access point installed at a house of each student and the like, a public wireless LAN access point installed in a town, a wireless access point of a provider under contract, or the like.

The decision unit 12 decides whether a student is present in a first area, based on an IP address of the student terminal 20. IP addresses of one or a plurality of wireless LAN access points installed in the first area are stored in advance in the storage unit 14. When the IP address of the student terminal 20 and the IP address of the wireless LAN access point installed in the first area coincide with each other, the decision unit 12 decides that the student who uses the student terminal 20 is present in the first area. On the other hand, when the IP address of the student terminal 20 and the IP address of the wireless LAN access point installed in the first area do not coincide with each other, the decision unit 12 decides that the student who uses the student terminal 20 is not present in the first area.

A student who uses each student terminal 20 can be determined by using log-in information to each student terminal 20, and the like, for example. Details of the first area will be described below in the following example embodiment.

The attendance check unit 13 performs an attendance check of a student, based on a result of a decision whether the student is present in the first area. Specifically, the attendance check unit 13 decides that the student present in the first area attends, and decides that the student not present in the first area is absent. The attendance check unit 13 registers a decision content in attendance data indicating attendance of each student. The storage unit 14 stores the attendance data.

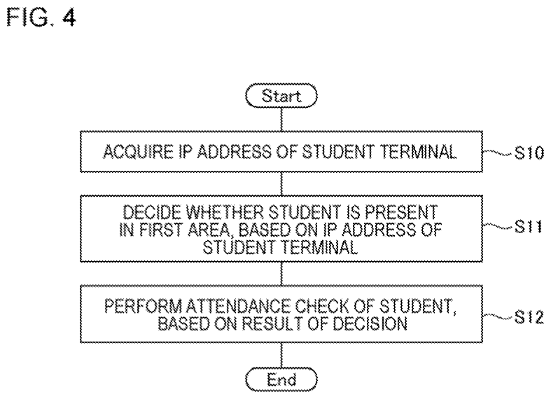

Next, one example of a flow of processing of the processing apparatus 10 will be described by using a flowchart in FIG. 4.

When the processing apparatus 10 acquires an IP address of each of the plurality of student terminals 20 (S10), the processing apparatus 10 decides whether a student is present in the first area, based on the IP address (S11). Then, the processing apparatus 10 performs an attendance check of the student, based on a result of the decision whether the student is present in the first area (S12). Specifically, the processing apparatus 10 decides that the student present in the first area attends, and decides that the student not present in the first area is absent.

### “Advantageous Effect”

The attendance check system according to the present example embodiment achieves an attendance check technique that can be used at school being prepared for one student to use one student terminal 20. Then, an attendance check is performed by using the student terminal 20, and thus labor and time of a teacher can be further reduced as compared to a conventional means such as a roll call. Further, a position of a student is checked by using an IP address of the student terminal 20, and an attendance check is performed based on the result, and thus a highly reliable attendance check is achieved with a relatively simple configuration.

### Second Example Embodiment

In the present example embodiment, the configuration of the attendance check system according to the first example embodiment is further embodied.

“Timing at which Attendance Check is Performed”

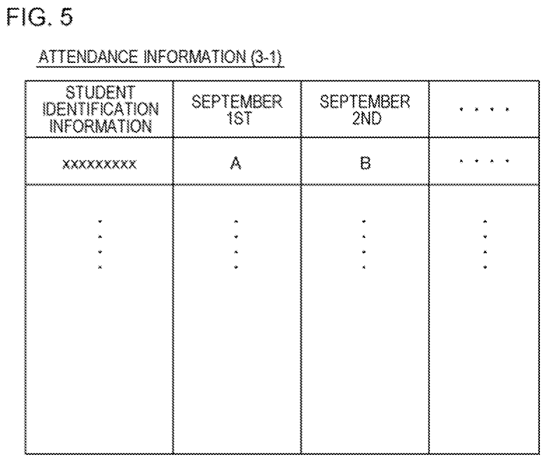

For example, at a starting timing of opening of one day, a decision unit 12 may decide whether a student is present in a first area, and an attendance check unit 13 may then perform an attendance check. In this case, as illustrated in FIG. 5, the attendance check unit 13 can update attendance data indicating an attendance situation of each day. In FIG. 5, “A” indicates attendance, and “B” indicates absence.

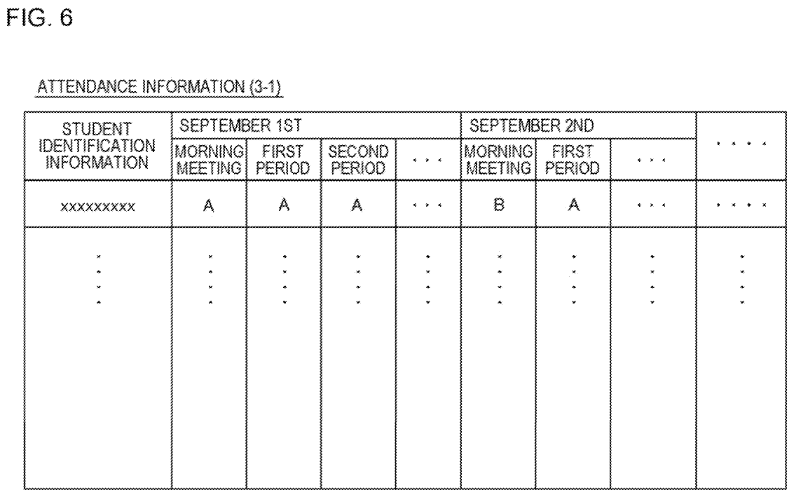

In addition, in addition to a starting timing of opening of one day, at a starting timing of each of a plurality of classes held in one day, the decision unit 12 may decide whether a student is present in the first area, and the attendance check unit 13 may perform an attendance check. In this case, as illustrated in FIG. 6, the attendance check unit 13 updates attendance data indicating an attendance situation of each class. In FIG. 6, “A” indicates attendance, and “B” indicates absence.

The decision unit 12 decides whether a student is present in the first area, based on an IP address of a student terminal 20 acquired in an attendance check time period being predefined. The attendance check time period is set in such a way as to include at least one of a starting timing of opening, a starting timing of a morning meeting, and a starting timing of each of a plurality of classes.

For example, when a starting timing of opening is 8:30, the attendance check time period may be set between 8:20 and 8:40. Further, when a starting timing of a morning meeting is 8:40, the attendance check time period may be set between 8:30 and 8:50. Further, when a starting timing of each of a plurality of classes is 9 o'clock, 10 o'clock, 11 o'clock, and the like, the attendance check time period may be set between 8:55 and 9:05, between 9:55 and 10:05, between 10:55 and 11:05, and the like. Note that, these are merely examples, which are not limited thereto.

Note that, an acquisition unit 11 may perform processing of acquiring an IP address of the student terminal 20 only in an attendance check time period. In addition, the acquisition unit 11 may regularly acquire an IP address of the student terminal 20 as log data for checking a usage situation of the student terminal 20 regardless of an attendance check time period.

### “Embodying of First Area”

### First Example

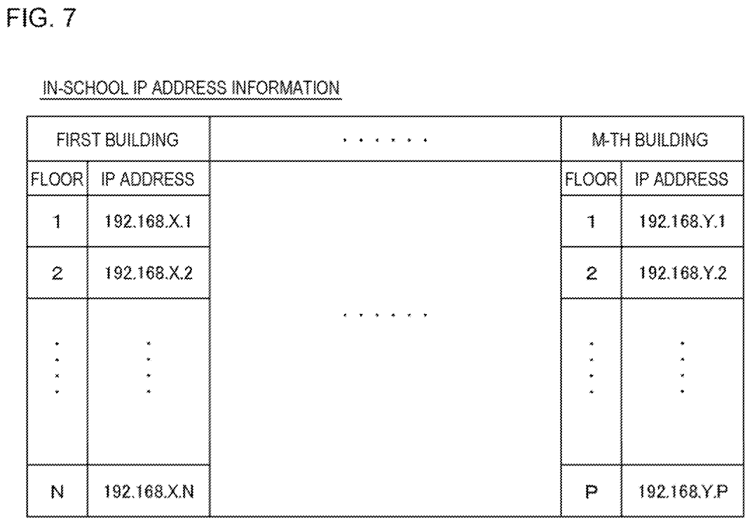

The first area in a first example is in a school. As illustrated in FIG. 7, IP addresses of one or a plurality of wireless LAN access points installed in a school are stored in advance in a storage unit 14. Note that, the IP address of the wireless LAN access point installed in a school is preferably a fixed IP address. In a case of a dynamic IP address, a means for updating in-school IP address information as illustrated in FIG. 7 in real time each time an IP address is changed is provided. Further, FIG. 7 illustrates an example in which a wireless LAN access point is installed for each floor of a building, but a wireless LAN access point may be installed by a different technique such as for each classroom.

The decision unit 12 decides whether a student is present in a school, based on a comparison result between an IP address of the student terminal 20 and an IP address of an access point installed in the school. Then, the attendance check unit 13 performs an attendance check of the student, based on a result of the decision whether the student is present in the school. Specifically, the attendance check unit 13 decides that the student present in the school attends, and decides that the student not present in the school is absent.

### Second Example

The first area in a second example is a partial area in a school, and is an area where a student needs to be present during an attendance check. The first area is a classroom where a morning meeting is held, a classroom where each class is held, or the like. The first area may vary for each student and for each timing at which an attendance check is performed.

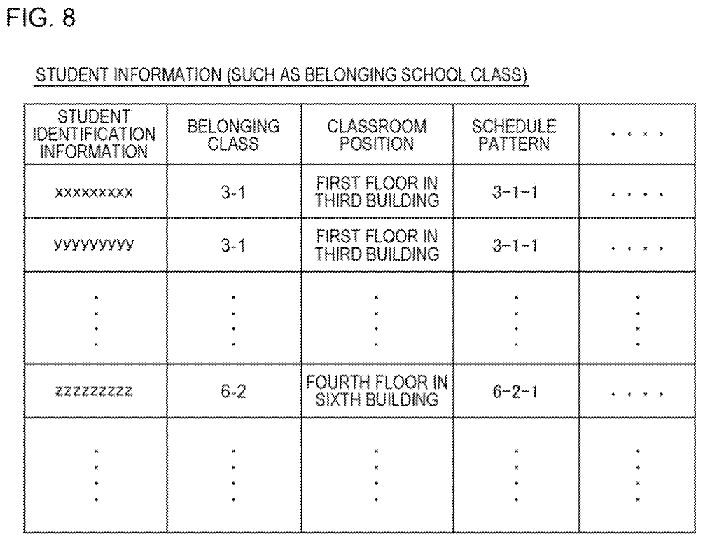

The decision unit 12 determines the first area of each of a plurality of students, based on student information indicating the first area of each of the plurality of students. FIG. 8 schematically illustrates one example of the student information. The student information includes a belonging school class of each of the plurality of students, a classroom position indicating a location of a classroom of the school class, a schedule pattern of the school class, and the like. By searching for schedule database with a schedule pattern as a key, data indicating a specific content of a schedule and a place (such as a classroom, a gymnasium, and a playground) where each class is held can be accessed.

For example, a morning meeting is held in a classroom of each school class. In this case, a classroom position of the student information illustrated in FIG. 8 is the first area at a starting timing of opening of each student or a starting timing of a morning meeting. Further, the first area of each student at a starting timing of each of a plurality of classes is determined based on a schedule of each student determined by the schedule pattern illustrated in FIG. 8. A class held in each time period and a place where the class is held are determined based on a schedule of each student. The place determined in such a manner is the first area of each student at a starting timing of each of a plurality of classes.

The decision unit 12 decides whether a student is present in the first area determined as described above, based on a comparison result between an IP address of the student terminal 20 and an IP address (see FIG. 7) of an access point installed in a school. Then, the attendance check unit 13 performs an attendance check of the student, based on a result of the decision whether the student is present in the first area. Specifically, the attendance check unit 13 decides that the student present in the first area attends, and decides that the student not present in the first area is absent.

### Third Example

The first area in a third example is an out-of-school area where a student is present when the student participates in an online class. The online class is a class taken via the student terminal 20 by a student outside a school by operating the student terminal 20 and being connected to a server of the school.

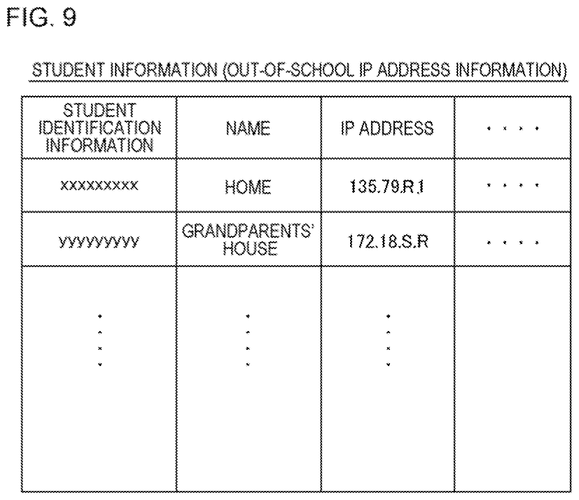

For example, a home, a grandparents' house, a relative's house, a dormitory, and the like are an out-of-school area. Which is set as the out-of-school area may be able to be selected for each student. Then, as illustrated in FIG. 9, an IP address related to the out-of-school area is registered in advance for each student in a processing apparatus 10. The storage unit 14 stores the information as illustrated in FIG. 9. The IP address related to the out-of-school area is an IP address of a wireless LAN access point installed in the out-of-school area. In the example illustrated in FIG. 9, student identification information, a name of an out-of-school area, and an IP address related to the out-of-school area are registered in association with one another.

The decision unit 12 decides whether a student is present in an out-of-school area, based on a comparison result between an IP address of the student terminal 20 and an IP address (see FIG. 9) related to the out-of-school area of each student. When the IP address of the student terminal 20 and the IP address related to the out-of-school area of each student coincide with each other, the decision unit 12 decides that the student who uses the student terminal 20 is present in the out-of-school area. On the other hand, when the IP address of the student terminal 20 and the IP address related to the out-of-school area of each student do not coincide with each other, the decision unit 12 decides that the student who uses the student terminal 20 is not present in the out-of-school area.

Then, the attendance check unit 13 performs an attendance check of the student, based on a result of the decision whether the student is present in the out-of-school area. Specifically, the attendance check unit 13 decides that the student present in the out-of-school area attends, and decides that the student not present in the out-of-school area is absent.

### Fourth Example

The first area in a fourth example is a concept including both of the first area in the first example and the first area in the third example. As another example, the first area in the fourth example may be a concept including both of the first area in the second example and the first area in the third example. For example, a case where a student who receives a class at school and a student who receives a class online are mixed is conceivable. By combining the techniques in the first example and the third example or combining the techniques in the second example and the third example, an attendance check of both of a student who receives a class at school and a student who receives a class online can be performed.

### “First Processing for Absent Student”

The processing apparatus 10 may be configured to perform processing described below.

An IP address related to a second area where a student is present during absence is registered in advance for each student. For example, a home, a grandparents' house, a relative's house, a dormitory, and the like are the second area. Which is set as the second area may be able to be selected for each student. Then, as illustrated in FIG. 9, an IP address related to the second area is registered in advance for each student in the processing apparatus 10. The storage unit 14 stores the information as illustrated in FIG. 9. The IP address related to the second area is an IP address of a wireless LAN access point installed in the second area. In the example illustrated in FIG. 9, student identification information, a name of a second area, and an IP address related to the second area are registered in association with one another.

Then, when the decision unit 12 decides that a student is not present in the first area, based on an IP address of the student terminal 20, the decision unit 12 decides whether the student is present in the second area, based on the IP address of the student terminal 20. When the IP address of the student terminal 20 and the IP address related to the second area of each student coincide with each other, the decision unit 12 decides that the student who uses the student terminal 20 is present in the second area. On the other hand, when the IP address of the student terminal 20 and the IP address related to the second area of each student do not coincide with each other, the decision unit 12 decides that the student who uses the student terminal 20 is not present in the second area.

The decision unit 12 may register, in the attendance information as illustrated in FIGS. 5 and 6, a decision result of whether a student is present in the second area in association with the student who is absent. When a teacher can confirm that the student who is not present in the first area and is absent is present in the second area being registered in advance, the teacher can be relieved. By performing the processing, information for relief can be provided to a teacher.

### “Second Processing for Absent Student”

The processing apparatus 10 may be configured to perform processing described below.

The storage unit 14 stores, for each student, absence contact information indicating presence or absence of absence contact. A means for updating the absence contact information is not particularly limited. For example, the processing apparatus 10 may receive an input from a teacher or a clerk of a school who receives absence contact from a guardian of a student by telephone, e-mail, or the like, and may update the absence contact information, based on the input. In addition, a guardian of a student may be able to log in to a school system with predetermined user identification information, and may perform absence registration. Then, a content of the absence registration being performed online in such a manner may be reflected in the absence contact information. In addition, the absence contact information may be updated by the technique disclosed in PTL 1.

The processing apparatus 10 extracts a “student whose attendance information is absent without attendance contact”, based on the attendance information as illustrated in FIGS. 5 and 6 and the absence contact information described above. Then, the processing apparatus 10 performs predetermined processing, based on an extraction result.

For example, the processing apparatus 10 may notify a teacher of a name of an extracted student. As a notification means, transmission of e-mail to an e-mail address of a teacher being registered in advance, a notification using a predetermined application (such as a notification on a page after logging in to the application and a push notification), a notification on a page after logging in to a predetermined school system, and the like are exemplified, which are not limited thereto.

In addition, the processing apparatus 10 may notify a guardian of an extracted student of “absence of a student without absence contact”. As a notification means, transmission of e-mail to an e-mail address of a guardian being registered in advance, a notification using a predetermined application (such as a notification on a page after logging in to the application and a push notification), a notification on a page after logging in to a predetermined school system, and the like are exemplified, which are not limited thereto.

The other configuration of an attendance check system according to the present example embodiment is similar to that in the first example embodiment.

The attendance check system according to the present example embodiment achieves an advantageous effect similar to that in the first example embodiment.

Further, the attendance check system according to the present example embodiment can perform an attendance check, based on an IP address of the student terminal 20 acquired in an attendance check time period being predefined. Thus, the attendance check can be accurately performed. Further, the attendance check can also be performed for each class by setting a plurality of attendance check time periods during a day.

Further, the attendance check system according to the present example embodiment can perform an attendance check of a student, based on whether the student is present in a school. Thus, the attendance check can be accurately performed.

Further, the attendance check system according to the present example embodiment can perform an attendance check of a student, based on whether the student is present in a predetermined partial area. The attendance check can be performed for each class by appropriately setting the predetermined partial area.

Further, the attendance check system according to the present example embodiment can perform an attendance check of a student, based on whether the student is present in an area (such as a home) where the student is present when the student participates in an online class. Thus, the attendance check can be accurately performed.

Further, when the attendance check system according to the present example embodiment decides that a student is not present in a predetermined first area, the attendance check system can decide whether the student is present in a second area where the student is present during absence. A teacher can be relieved based on a result of the decision.

Note that, in the present specification, “acquisition” includes at least any one of “acquisition of data stored in another apparatus or a storage medium by its own apparatus (active acquisition)”, based on a user input or an instruction of a program, such as reception by making a request or an inquiry to another apparatus and reading by accessing to another apparatus or a storage medium, “inputting of data output to its own apparatus from another apparatus (passive acquisition)”, based on a user input or an instruction of a program, such as reception of data to be distributed (transmitted, push-notified, or the like) and acquisition by selection from among received data or received information, and “creation of new data by editing data (such as texting, sorting of data, extraction of a part of data, and change of a file format) and the like, and acquisition of the new data”.

A part or the whole of the above-described example embodiment may also be described in supplementary notes below, which is not limited thereto.

1. A processing apparatus, including:

an acquisition unit that acquires an IP address of a student terminal;

a decision unit that decides whether a student is present in a first area, based on an IP address of the student terminal; and

an attendance check unit that performs an attendance check of a student, based on a result of a decision whether a student is present in the first area.

2. The processing apparatus according to supplementary note 1, wherein

the first area is in a school,

the decision unit decides whether a student is present in a school, based on an IP address of the student terminal, and

the attendance check unit performs an attendance check of a student, based on a result of a decision whether a student is present in a school.

3. The processing apparatus according to supplementary note 1, wherein

the first area is a partial area in a school, and is an area where a student needs to be present during an attendance check,

a plurality of access points are present in a school,

the decision unit
determines the first area of each of a plurality of students, based on student information indicating the first area of each of a plurality of students, and
   decides whether a student is present in the first area, based on an IP address of the student terminal, and

the attendance check unit performs an attendance check of a student, based on a result of a decision whether a student is present in the first area.

4. The processing apparatus according to supplementary note 1, wherein

the first area is an out-of-school area where a student is present when the student participates in an online class,

an IP address related to the out-of-school area is registered in advance for each student,

the decision unit decides whether a student is present in the out-of-school area, based on an IP address of the student terminal, and

the attendance check unit performs an attendance check of a student, based on a result of a decision whether a student is present in the out-of-school area.

5. The processing apparatus according to any of supplementary notes 1 to 4, wherein

the decision unit decides whether a student is present in the first area, based on an IP address of the student terminal acquired in an attendance check time period being predefined.

6. The processing apparatus according to supplementary note 5, wherein

the attendance check time period is set in such a way as to include at least one of a starting timing of opening, a starting timing of a morning meeting, and a starting timing of each of a plurality of classes.

7. The processing apparatus according to any of supplementary notes 1 to 6, wherein

an IP address related to a second area where a student is present during absence is registered in advance for each student, and,

when the decision unit decides that a student is not present in the first area, the decision unit decides whether a student is present in the second area, based on an IP address of the student terminal.

8. An attendance check system, including:

the processing apparatus according to any of supplementary notes 1 to 7; and a student terminal.

9. A processing method, including,

executed by a computer;

an acquisition step of acquiring an IP address of a student terminal;

a decision step of deciding whether a student is present in a first area, based on an IP address of the student terminal; and

an attendance check step of performing an attendance check of a student, based on a result of a decision whether a student is present in the first area.

10. A program causing a computer to function as:

an acquisition unit that acquires an IP address of a student terminal;

a decision unit that decides whether a student is present in a first area, based on an IP address of the student terminal; and

an attendance check unit that performs an attendance check of a student, based on a result of a decision whether a student is present in the first area.
10 Processing apparatus
11 Acquisition unit
12 Decision unit
13 Attendance check unit
14 Storage unit
Student terminal
1A Processor
2A Memory
3A Input/output interface
4A Peripheral circuit
5A Bus

1. A processing apparatus, comprising:
at least one memory configured to store one or more instructions; and
at least one processor configured to execute the one or more instructions to:
acquire an internet protocol (IP) address of a student terminal;
decide whether a student is present in a first area, based on an IP address of the student terminal; and
perform an attendance check of a student, based on a result of a decision whether a student is present in the first area.

2. The processing apparatus according to claim 1, wherein
the first area is in a school,
the processor is further configured to execute the one or more instructions to:
decide whether a student is present in a school, based on an IP address of the student terminal, and
perform an attendance check of a student, based on a result of a decision whether a student is present in a school.

3. The processing apparatus according to claim 1, wherein
the first area is a partial area in a school, and is an area where a student needs to be present during an attendance check,
a plurality of access points are present in a school,
the processor is further configured to execute the one or more instructions to:
determine the first area of each of a plurality of students, based on student information indicating the first area of each of a plurality of students, and
decide whether a student is present in the first area, based on an IP address of the student terminal, and
perform an attendance check of a student, based on a result of a decision whether a student is present in the first area.

4. The processing apparatus according to claim 1, wherein
the first area is an out-of-school area where a student is present when the student participates in an online class,
an IP address related to the out-of-school area is registered in advance for each student,
the processor is further configured to execute the one or more instructions to:
decide whether a student is present in the out-of-school area, based on an IP address of the student terminal, and
perform an attendance check of a student, based on a result of a decision whether a student is present in the out-of-school area.

5. The processing apparatus according to claim 1, wherein
the processor is further configured to execute the one or more instructions to decide whether a student is present in the first area, based on an IP address of the student terminal acquired in an attendance check time period being predefined.

6. The processing apparatus according to claim 5, wherein
the attendance check time period is set in such a way as to include at least one of a starting timing of opening, a starting timing of a morning meeting, and a starting timing of each of a plurality of classes.

7. The processing apparatus according to claim 1, wherein
an IP address related to a second area where a student is present during absence is registered in advance for each student, and,
the processor is further configured to execute the one or more instructions to decide whether a student is present in the second area, based on an IP address of the student terminal, when deciding that a student is not present in the first area

8. An attendance check system, comprising:
the processing apparatus according to claim 1; and a student terminal.

9. A processing method, comprising,
executed by a computer;
acquiring an IP address of a student terminal;
deciding whether a student is present in a first area, based on an IP address of the student terminal; and
performing an attendance check of a student, based on a result of a decision whether a student is present in the first area.

10. A non-transitory storage medium storing a program causing a computer to:
acquire an IP address of a student terminal;
decide whether a student is present in a first area, based on an IP address of the student terminal; and
perform an attendance check of a student, based on a result of a decision whether a student is present in the first area.
